(19) United States
(12) Patent Application Publication
(10) Pub. No.: US 2026/0017879 A1
(43) Pub. Date: Jan. 15, 2026

(54) TRANSFORMING DIGITAL IMAGES OF ARCHIVAL MATERIALS INTO DIMENSIONALLY ACCURATE VIRTUAL OBJECTS

(71) Applicant: University of Southern California, Los Angeles, CA (US)

(72) Inventors: Sean Patrick Fraga, Los Angeles, CA (US); Shih Hsuan Huang, Los Angeles, CA (US); Christy Sze Ye, Los Angeles, CA (US)

(21) Appl. No.: 19/330,329

(22) Filed: Sep. 16, 2025

Related U.S. Application Data
(63) Continuation-in-part of application No. PCT/US2024/021114, filed on Mar. 22, 2024.
(60) Provisional application No. 63/456,378, filed on Mar. 31, 2023.

(51) Int. Cl. G06T 17/00; G06T 15/04; G06V 10/44

(52) U.S. Cl. CPC G06T 17/00; G06T 15/04; G06V 10/44

(57) ABSTRACT

Aspects of this technical solution can determine, according to an attribute of a digital image and a type of a physical object depicted in the digital image, a physical dimension of the physical object, and generate a three-dimensional virtual object corresponding to the physical object, the virtual object having a virtual dimension in a virtual environment corresponding to the physical dimension.

### CROSS-REFERENCE TO RELATED PATENT APPLICATIONS

This application claims the benefit of priority under 35 U.S.C. § 119 to P.C.T. Application PCT/US2024/021114, filed Mar. 21, 2024, and U.S. Provisional Patent Application Ser. No. 63/456,378, filed Mar. 31, 2023, the contents of such are being hereby incorporated by reference in their entirety and for all purposes as if completely and fully set forth herein.

### FEDERALLY SPONSORED RESEARCH OR DEVELOPMENT

This invention was made with government support under Grant Number HAA-287859-22, awarded by the National Endowment for the Humanities (“NEH”). The government has certain rights in the invention.

### TECHNICAL FIELD

The present implementations relate generally to image processing, including but not limited to transforming digital images of archival materials into dimensionally accurate virtual objects.

### BACKGROUND

Perceived realism of a virtual object may rely on dimensional accuracy. However, even though institutions (e.g., museums, archives, libraries) have digitized millions of items in respective collections, the institutions may lack information on physical dimensions of the items in the collections in computer-readable formats, creating obstacles in generating virtual objects of the items with dimensional accuracy.

### SUMMARY

This technical solution is directed determining physical dimensions from a digital image (e.g., two-dimensional (2D) image) of an object, and producing virtual objects (e.g., three-dimensional (3D) representation) based on at least one of the digital image or data associated with the digital image. For example, some institutions (e.g., galleries, libraries, archives, museums, etc.) may digitize physical objects from a collection of objects. Institutions may provide physical dimensions (e.g., measured dimensions, etc.) of each object, and may store data having various particular attributes or characteristics (e.g., pixel density) that can be correlated with physical dimensions. The systems and methods of the present disclosure can receive at least one of the digital image or the data associated with a physical object, and output the physical dimensions corresponding to the physical object.

At least one aspect is directed to a system. The system can include a memory and one or more processors. The system can determine, according to an attribute of a digital image and a type of a physical object depicted in the digital image, a physical dimension of the physical object. The system can generate a three-dimensional virtual object corresponding to the physical object, the virtual object having a virtual dimension in a virtual environment corresponding to the physical dimension.

At least one aspect is directed to a method. The method can include determining, according to an attribute of a digital image and a type of a physical object depicted in the digital image, a physical dimension of the physical object. The method can include generating a three-dimensional virtual object corresponding to the physical object, the virtual object having a virtual dimension in a virtual environment corresponding to the physical dimension.

At least one aspect is directed to a non-transitory computer readable medium that can include one or more instructions stored thereon and executable by a processor. The processor can determine, according to an attribute of a digital image and a type of a physical object depicted in the digital image, a physical dimension of the physical object. The processor can generate a three-dimensional virtual object corresponding to the physical object, the virtual object having a virtual dimension in a virtual environment corresponding to the physical dimension.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 illustrates a flow diagram for transforming digital images of archival materials into dimensionally accurate virtual objects, in accordance with present implementations.

FIG. 2 illustrates an example method for transforming digital images of archival materials into dimensionally accurate virtual objects, in accordance with present implementations.

FIG. 3 depicts an example computing device according to this disclosure.

FIG. 4 depicts an example computing device according to this disclosure.

FIG. 5 depicts an example method of transforming digital images of archival materials into dimensionally accurate virtual objects, according to this disclosure.

FIG. 6 depicts an example method of transforming digital images of archival materials into dimensionally accurate virtual objects, according to this disclosure.

FIG. 7 depicts an example method of transforming digital images of archival materials into dimensionally accurate virtual objects, according to this disclosure.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

Cultural heritage institutions (e.g., galleries, libraries, archives, museums, etc.) have increasingly digitized physical objects from their collections. However, such institutions may not provide physical dimensions for the digitized objects. Thus, physical dimensions of the physical object may be difficult to derive from a digital image of the physical object.

The systems and methods of the present disclosure can determine physical dimensions of the physical objects depicted in the digital images based on at least one of the digital image or data associated with the digital image. For example, the systems and methods may determine the pixel dimensions of the digital image, together with information about the digitization and image storage procedures of host institutions, to calculate the physical dimensions of the original physical object. As another example, the systems and methods may determine the pixel dimensions from at least one of the metadata associated with the digital image or pixel dimensions of the object depicted in the digital image. The systems and methods of the present disclosure can leverage industry digitization standards to establish a relationship between physical dimensions and pixel dimensions, which may be referred to as a conversion ratio. The conversion ratio may vary by institution, collection, and item type, and thus the method may include encoding various conversion ratios appropriate to different scenarios in a set of reference tables.

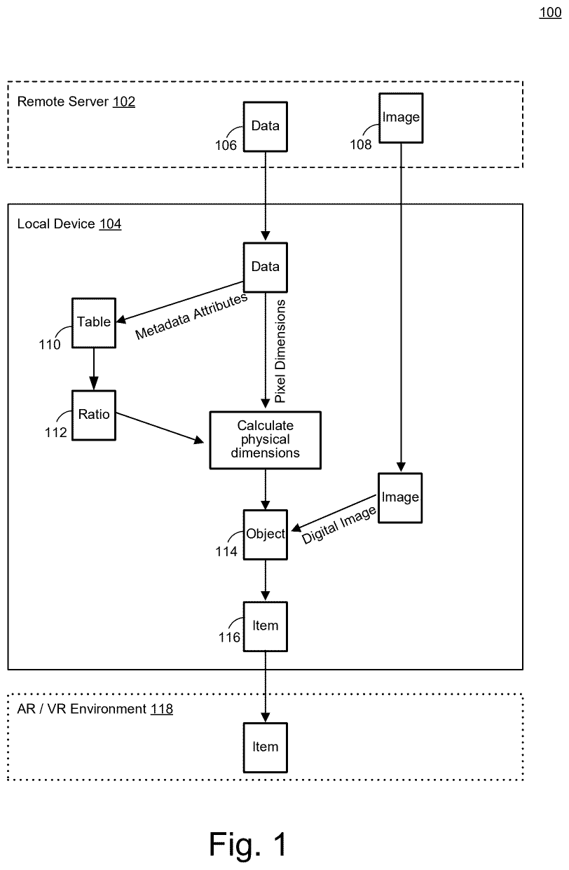

FIG. 1 illustrates a system 100 for transforming digital images of archival materials into dimensionally accurate virtual objects, in accordance with present implementations. The system 100 can transform existing digital images of 2D objects into dimensionally accurate 3D virtual objects suitable for display and interaction in augmented reality (AR) and virtual reality (VR) environments. AR environments blend virtual objects into the physical world, while VR environments immerse the user in a virtual world. In both AR and VR environments, the dimensional accuracy of a given virtual object may enhance perceived realism and, by extension, the perceived realism of the larger AR or VR experience.

The system 100 can use calculated physical dimensions of a physical object in a digital image to create a virtual object that based on at least one of the dimensions, proportion, or appearance of the physical object. A user can view, manipulate, and interact with this dimensionally-accurate virtual object in AR or VR. In some cases, the system 100 can generate virtual objects that are dimensionally accurate to within ˜10% of the physical object, which may preserve the perceived realism of the object during user viewing and interaction.

The system 100 can include a remote server 102. The remote server 102 can include one or more digitized collections of one or more institutions, such as galleries, museums, or other such institutions. The remote server 102 can store a plurality of images 108 depicting objects digitized by the institutions. The objects can include any historical artefact, such as but not limited to, boxes, jars, paintings, or any other cultural heritage items. The remote server 102 can include data 106 such as metadata 106 associated with the images 108. The metadata 106 can include at least one of a number of pixels, date, pixel density, physical dimensions, or any other information associated with the images 108.

The system 100 can include a local device 104 (e.g., client device, etc.) which can include any of a computer, mobile phone, or any other device including one or more processors. The local device 104 can retrieve at least one image 108 from the remote server 102 in response to receiving user input. The local device 104 can include at least one software application, herein referred to as an app, that can be configured to retrieve the image 108, determine the physical dimension of the physical object depicted in the image 108, and generate a virtual representation of the image 108 based at least on the physical dimension. The local device 104 can retrieve the metadata 106 associated with the image 108. In some implementations, the local device 104 can retrieve a plurality of images 108 and associated metadata 106 from the remote server 102. The local device 104 can include at least one storage device such as a database, and can store the images 108 and metadata 106 in the storage device.

The system 100 can generate a virtual object 114 based on at least one of the image 108 or the metadata 106. In some implementations, the system 100 generates the virtual object 114 in response to a user initiating an augmented reality (AR) session. The system 100 can generate the virtual object 114 corresponding to a selected item (e.g., given item) by the user.

When a user initiates an AR session with a given item, the app uses the item metadata 106 and digital image(s) 108 to create a virtual object 114 bast at least on physical dimensions of the object in the digital image 108, proportions, and appearance. To create the virtual object 114, the app converts pixel dimensions to physical dimensions in, for example, meters, or any other unit of measurement. The app can use a set of reference tables 110 including conversion ratios (e.g., conversion ratios 112) to convert the pixel dimensions to the physical dimension. The reference tables 110 can be stored in the local device 104 and can be accessed at runtime to fulfill user requests. Each of the reference tables 110 can correspond to a host institution, and each of the reference tables 110 can have different conversion ratios 112.

In response to a user initiating an AR session with a given item, the app retrieves the item metadata 106 from device storage, determines at least one of the host institution name or object type, and determines the corresponding reference table 110 in device storage to look up the corresponding conversion ratio 112. In some implementations, the app can use attributes other than the host institution or object type to determine the conversion ratio 112, such as the collection of the object or a unique identifier of the object, either in addition to or instead of the object type. The object type can include at least one of a painting, sculpture, or any other object.

The app can determine the pixel dimensions of the digital image(s) 108 of the object. The system 100 can determine the pixel dimensions from the metadata 106. In some implementations, the system 100 can determine the pixel dimensions from the digital image(s) 108, such as by performing image processing.

The app can use the conversion ratio 112 and the pixel dimensions to determine the physical dimension. For example, the app can multiply a height dimensions (e.g., in pixels) of the digital image by the conversion ratio 112 to determine a physical height dimensions (e.g., in meters, centimeters, or any other measurement unit) of the virtual object. The app can multiply width dimensions (e.g., in pixels) of the digital image by the conversion ratio 112, to determine physical width dimensions (e.g., in meters, centimeters, or any other measurement unit) of the virtual object. The physical dimensions can represent the length and width dimensions of the virtual object representative the physical object depicted in the image 108. The app can store both dimensions in device memory (e.g., of the local device 104).

The system 100 can generate a virtual object based on at least the physical dimensions of the physical object depicted in the image 108, proportions, and appearance. The app retrieves, from device memory, the length and width dimensions for a virtual object 114 corresponding to the physical object. Since the physical item is depicted in 2D, the app can specify the height of the virtual object 114 as 0 (e.g., zero) meters. The app can provide the physical dimensions to a virtual object generation engine of the device (e.g., local device 104), with instructions to generate a 3D virtual object 114 with the specified physical length, width, and height. The virtual object generation engine can generate a virtual object 114 including a blank (e.g., untextured) rectangular plane that matches the physical dimensions and proportions of the physical object. The app can retrieve from device memory the digital image(s) 108 corresponding to the physical object. The app can provide the digital image(s) 108 to the virtual object generation engine of the device, with instructions to apply the image(s) to the virtual object 114 as a texture, orienting the image(s) 108 to match the proportions of the virtual object 114. The virtual object generation engine can generate an item 116 (e.g., 3D representation of the 2D object in the image 108) that matches the visual appearance of the physical object depicted in the image 108 and described by the metadata 106. The item 116 can be a 3D virtual object corresponding to the physical object depicted in the image 108. The virtual object generation engine can generate the item 116 using at least the physical dimensions. The app displays the item 116 to the user in an AR/VR environment 118. For example, the app can transmit the item 116 to the AR/VR environment 118.

In some examples, a device (e.g., local device 104) may determine a conversion ratio 112. For example, the device may access a record (e.g., in memory, from a cloud, from another device) stored in a database (e.g., a reference table). The record may include the conversion ratio 112. In some cases, an operator, a computer, or other device, may calculate the conversion ratio 112 and input the calculated conversion ratio 112 into the database. In some cases, the device may calculate the conversion ratio 112. The device may input the calculated conversion ratio 112 into the database.

The conversion ratio 112 may be a decimal that encodes the mathematical relationship between the pixel dimensions and the physical dimensions for objects of the specified type held by the specified archive. The value of the conversion ratio 112 may be calculated by multiplying together three numbers. The first number included in the conversion ratio 112 can convert the pixel dimensions of at least one of the physical object or the digital image 108 into physical dimensions. Institutions may digitize different items at different resolutions, depending on the object type and object collection. The first number can be the multiplicative inverse (or reciprocal) of a digitization resolution for objects of a specified type. For example, the reciprocal of an original digitization resolution of 400 pixels per inch (ppi) is 1/400, which equals 0.0025. The second number included in the conversion ratio 112 can reverse any scaling and restore original dimensions of the physical object. Institutions may scale down images 108 to minimize storage and bandwidth, but scaling down can complicate efforts to determine original dimensions of an object. The second number can be the reciprocal of any scaling factor applied by the institutions to images for object type. For example, in response to an institution reducing images by half, the scaling factor is ½ and the reciprocal is 2/1, or 2.

The third number included in the conversion ratio 112 can be the conversion ratio from a first unit of measurement (e.g., inches) to a second unit of measurement (e.g., meters). For example, while inches are a typical unit of measure in digitization contexts, virtual and augmented reality authoring environments may use meters. The third number can convert the dimensions of the physical object into dimensions for the virtual object, and can be a constant at 0.0254. The conversion ratio 112 is thus a numerical representation of an object digitization and image storage procedures of a given institution.

The following example may relate to calculating the conversion ratio 112 and may demonstrate how a conversion ratio 112 is calculated for one item type at one archive: books digitized by Library of Congress. The original scanning resolution for books digitized by Library of Congress is typically 400 ppi, the reciprocal of which is 1/400, or 0.0025. Library of Congress does not scale images of books, making the scaling factor 1, the reciprocal of which is 1. The conversion ratio 112 from inches to meters is constant at 0.0254. Multiplying these numbers together (0.0025*1*0.0254) produces a value of 0.0000635, the conversion ratio 112 for books digitized by Library of Congress. The system 100 can store the conversion ratio 112 in a reference table 110 for Library of Congress, for retrieval and use in response to a user initiating an AR session with a book they have downloaded from Library of Congress.

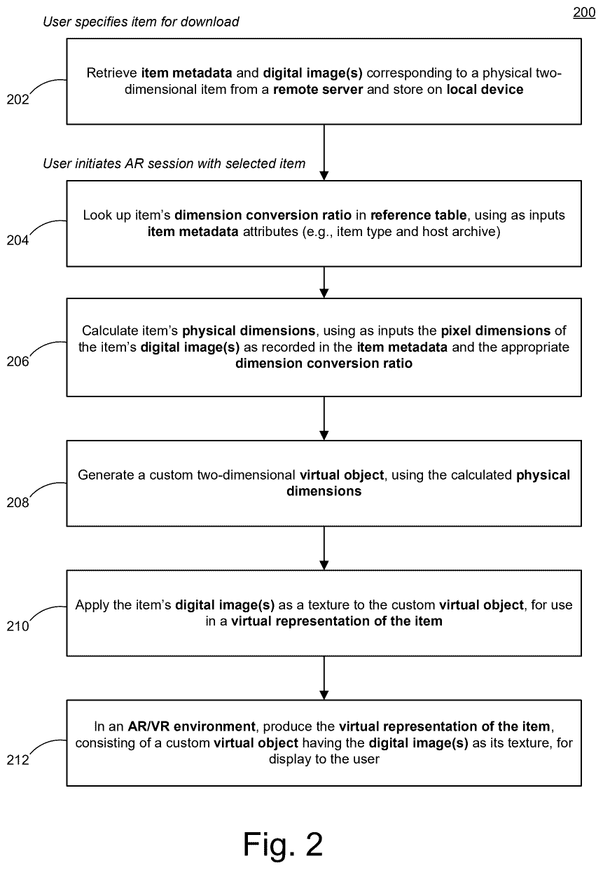

FIG. 2 illustrates an example method 200 for transforming digital images of archival materials into dimensionally accurate virtual objects, in accordance with present implementations.

At 202, a user may specify an item for download. A device (e.g., a processor) may retrieve item metadata and digital images corresponding to a physical two-dimensional item from a remote server and store on a local device (e.g., memory).

At 204, a user may initiate an AR session with a selected item. The device may look up a dimension conversion ratio of the item in a reference table, using as inputs item metadata attributes (e.g., item type and host archive).

At 206, the device may calculate physical dimensions of the item, using as inputs pixel dimensions of the digital images of the item as recorded in the item metadata and the dimension conversion ratio of the item.

At 208, the device may generate a custom two-dimensional virtual object using the calculated physical dimensions.

At 210, the device may apply the digital images of the item as a texture to the custom virtual object. In some cases, the custom virtual object with the texture may be used in a virtual representation of the item.

At 212, the device may produce, in an AR/VR environment, the virtual representation of the item comprising the custom virtual object having the digital images as texture for display to the user.

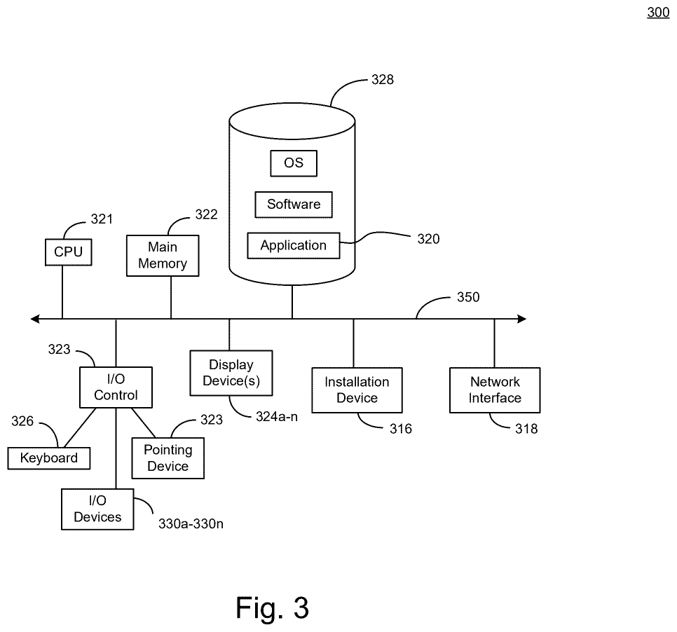

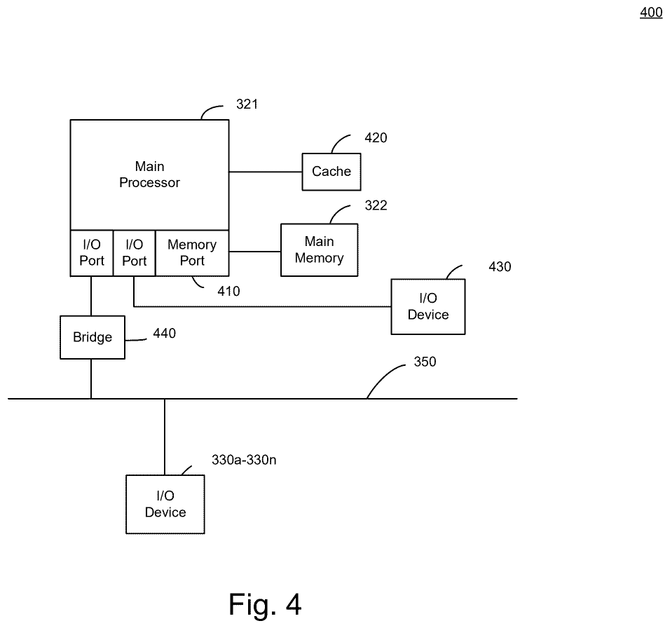

The systems discussed herein may be deployed as, and/or executed on, a computing device, such as a computer, network device or appliance capable of communicating on any type and form of network and performing the operations described herein. FIG. 3 and FIG. 4 depict block diagrams of a computing device 300 or 400 useful for practicing an implementation of the wireless communication devices or the access point. As shown in FIGS. 3 and 4, each computing device 300 or 400 includes a central processing unit 321, and a main memory unit 322. As shown in FIG. 3, a computing device 300 or 400 may include a storage device 328, an installation device 316, a network interface 318, and I/O controller 323, display devices 324a-324n, a keyboard 326 and a pointing device 327, such as a mouse. The storage device 328 may include, without limitation, an operating system and/or software. As shown in FIG. 4, each computing device 300 or 400 may also include additional optional elements, such as a memory port 410, a bridge 440, one or more input/output devices 330a-330n, and a cache memory 420 in communication with the central processing unit (CPU) 321.

The central processing unit 321 is any logic circuitry that responds to and processes instructions fetched from the main memory 322. In many implementations, the central processing unit 321 is provided by a microprocessor unit.

Main memory 322 may be one or more memory chips capable of storing data and allowing any storage location to be directly accessed by the central processing unit 321, such as any type or variant of Static random access memory (SRAM), Dynamic random access memory (DRAM), Ferroelectric RAM (FRAM), NAND Flash, NOR Flash, and Solid State Drives (SSD). The main memory 322 may be based on any of the above described memory chips, or any other available memory chips capable of operating as described herein. In the implementation shown in FIG. 3, the central processing unit 321 communicates with main memory 322 via a system bus 350 (described in more detail below). FIG. 4 depicts an implementation of a computing device 300 or 400 in which the processor communicates directly with main memory 322 via a memory port 410. For example, in FIG. 4 the main memory 322 may be DRDRAM.

FIG. 4 depicts an implementation in which the main processor 321 communicates directly with cache memory 420 via a secondary bus, sometimes referred to as a backside bus. In other implementations, the main processor 321 communicates with cache memory 420 using the system bus 350. Cache memory 420 typically has a faster response time than main memory 322 and is provided by, for example, SRAM, BSRAM, or EDRAM. In the implementation shown in FIG. 4, the main processor 321 communicates with various I/O devices 330a-n via a local system bus 350. Various buses may be used to connect the central processing unit 321 to any of the I/O devices 330a-n. For implementations in which the I/O device is a video display 324, the processor 321 may use an Advanced Graphics Port (AGP) to communicate with the display. FIG. 4 depicts an implementation of a computing device 300 or 400 in which the main processor 321 may communicate directly with I/O device 330b. FIG. 4 also depicts an implementation in which local busses and direct communication are mixed: the main processor 321 communicates with I/O device 330a using a local interconnect bus while communicating with I/O device 330b directly.

A wide variety of I/O devices 330a-330n may be present in the computing device 300 or 400. Input devices include keyboards, mice, trackpads, trackballs, microphones, dials, touch pads, touch screens, and drawing tablets. Output devices include video displays, speakers, inkjet printers, laser printers, projectors and dye-sublimation printers. The I/O devices may be controlled by an I/O controller as shown in FIG. 3. The I/O controller may control one or more I/O devices, such as a keyboard and a pointing device, e.g., a mouse or optical pen. Furthermore, an I/O device may also provide storage and/or an installation device 316 for the computing device 300 or 400 For example, the computing device 300 or 400 may provide USB connections (not shown) to receive handheld USB storage devices.

Referring again to FIG. 3, the computing device 300 or 400 may support any suitable installation device 316, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 300 or 400 may further include a storage device, such as one or more hard disk drives or redundant arrays of independent disks, for storing an operating system and other related software, and for storing application software programs such as any program or application 320 for implementing (e.g., configured and/or designed for) the systems and methods described herein. Optionally, any of the installation devices 316 could also be used as the storage device. Additionally, the operating system and the software can be run from a bootable medium.

Furthermore, the computing device 300 or 400 may include a network interface 318 to interface to the network through a variety of connections including, but not limited to, standard telephone lines, LAN or WAN links, broadband connections, wireless connections, or some combination of any or all of the above. Connections can be established using a variety of communication protocols. In one implementation, the computing device 300 or 400 communicates with other computing devices 300 or 400 via any type and/or form of gateway or tunneling protocol. The network interface 318 may include a built-in network adapter, network interface card, PCMCIA network card, card bus network adapter, wireless network adapter, USB network adapter, modem, or any other device suitable for interfacing the computing device 300 or 400 to any type of network capable of communication and performing the operations described herein.

In some implementations, the computing device 300 or 400 may include or be connected to one or more display devices 324a-324n. As such, any of the I/O devices 330a-330n and/or the I/O controller 323 may include any type and/or form of suitable hardware, software, or combination of hardware and software to support, enable or provide for the connection and use of the display device(s) 324a-324n by the computing device 300 or 400. For example, the computing device 300 or 400 may include any type and/or form of video adapter, video card, driver, and/or library to interface, communicate, connect or otherwise use the display device(s) 324a-324n. In one implementation, a video adapter may include multiple connectors to interface to the display device(s) 324a-324n. In other implementations, the computing device 300 or 400 may include multiple video adapters, with each video adapter connected to the display device(s) 324a-324n. In some implementations, any portion of the operating system of the computing device 300 or 400 may be configured for using multiple displays 324a-324n. In some implementations, a computing device 300 or 400 may be configured to have one or more display devices 324a-324n. In further implementations, an I/O device 430 may be a bridge between the system bus 350 and an external communication bus. For example, the I/O device 430 can be integrated within a mobile computing device (e.g., a smartphone, a tablet) including one or more sensors configured to determine, detect, or identify one or more or position and orientation of the mobile computing device with respect to one or more of a physical environment and a virtual environment. The sensors can include, but are not limited to, a camera, a gyroscope, an accelerometer, a range sensor (e.g., light detection and ranging, or “LiDAR”), or any combination thereof. For example, the image 108 can be based on data captured from the camera of the mobile computing device, and the data 106 can be based on data capture from one or more of the camera, the gyroscope, the accelerometer, and the range sensor. For example, the mobile computing device can present the AR/VR environment 118 at a display screen thereof, and can orient one or more virtual objects in the virtual environment.

A computing device 300 or 400 of the sort depicted in FIGS. 3 and 4 may operate under the control of an operating system, which controls scheduling of tasks and access to system resources. The computing device 300 or 400 can be running any desktop operating system, any embedded operating system, any real-time operating system, any open source operating system, any proprietary operating system, any operating systems for mobile computing devices, or any other operating system capable of running on the computing device and performing the operations described herein. The computing device 300 or 400 can be any workstation, telephone, desktop computer, laptop or notebook computer, server, handheld computer, mobile telephone or other portable telecommunications device, media playing device, gaming system, mobile computing device, or any other type and/or form of computing, telecommunications or media device that is capable of communication. The computing device 300 or 400 has sufficient processor power and memory capacity to perform the operations described herein. In some implementations, the computing device 300 or 400 may have different processors, operating systems, and input devices consistent with the device. For example, in one implementation, the computing device 300 or 400 is a smart phone, mobile device, tablet or personal digital assistant.

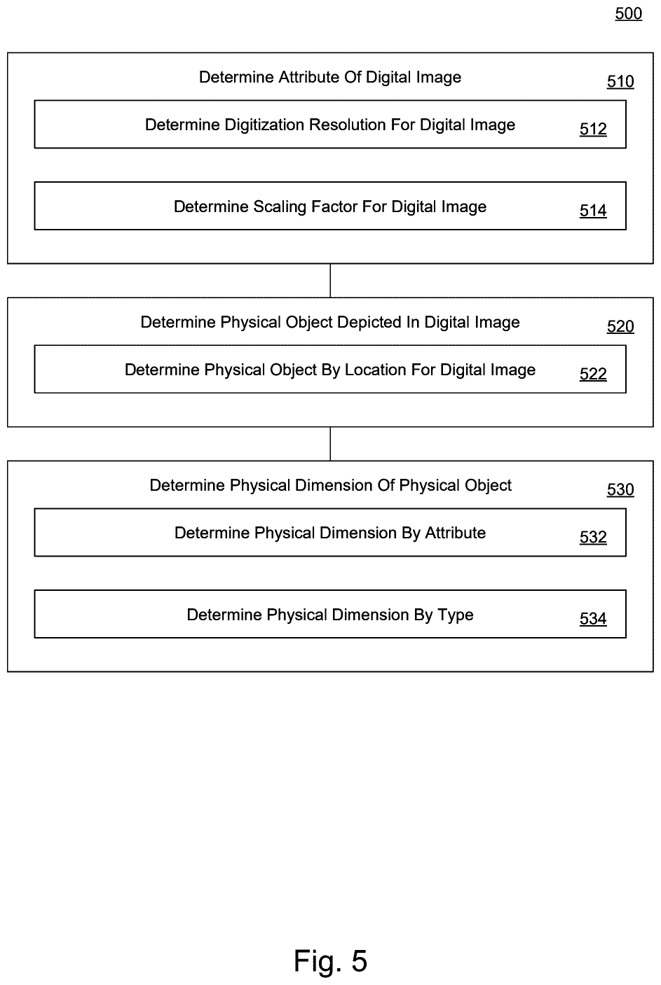

FIG. 5 depicts an example method of transforming digital images of archival materials into dimensionally accurate virtual objects according to this disclosure. At least one of the computing devices 300 or 400 can perform method 500. At 510, the method 500 can determine an attribute of a digital image. At 512, the method 500 can determine a digitization resolution for the digital image. For example, at least one of the computing device 300 or the computing device 400 can determine, according to the location, a digitization resolution for the digital image, where the attribute can include the digitization resolution. At 514, the method 500 can determine a scaling factor for the digital image. For example, at least one of the computing device 300 or the computing device 400 can determine, according to the location, a scaling factor for the digital image, where the attribute can include the scaling factor. For example, the local device 104 can generate the scaling factor, via one or more of the components of the system of FIG. 3 as discussed herein, but is not limited thereto.

At 520, the method 500 can determine a property of a physical object depicted in the digital image. For example, at least one of the computing device 300 or the computing device 400 can determine the property of the physical object according to at least one feature of the physical object depicted in the digital image. For example, at least one of the computing device 300 or the computing device 400 can determine, using a machine learning model configured to detect image features, the at least one feature of the physical object depicted in the digital image. At 522, the method 500 can determine the property according to a location for the digital image. For example, at least one of the computing device 300 or the computing device 400 can determine the property of the physical object according to an attribute of a location associated with the digital image. For example, at least one of the computing device 300 or the computing device 400 can determine that the location associated with the digital image is a physical location corresponding to at least one of a physical location, or an identifier of an institution. For example, at least one of the computing device 300 or the computing device 400 can determine that the location associated with the digital image is a logical address of a computing system associated with a physical location, or a logical address of the computing system associated with an institution.

At 530, the method 500 can determine a physical dimension of the physical object. At 532, the method 500 can determine the physical dimension according to the attribute. At 534, the method 500 can determine the physical dimension according to the type.

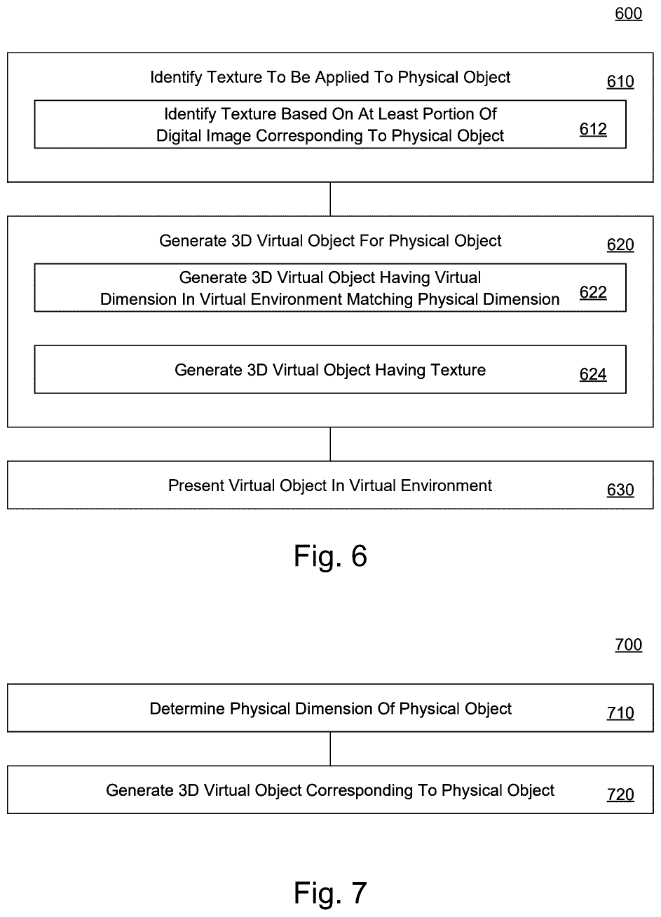

FIG. 6 depicts an example method of transforming digital images of archival materials into dimensionally accurate virtual objects according to this disclosure. At least one of the computing devices 300 or 400 can perform method 600. At 610, the method 600 can identify a texture to be applied to the virtual object. At 612, the method 600 can identify the texture based on at least a portion of the digital image corresponding to the physical object. At 620, the method 600 can generate a 3d virtual object for the physical object. At 622, the method 600 can generate the 3d virtual object having a virtual dimension in a virtual environment matching the physical dimension. At 624, the method 600 can generate the 3d virtual object having the texture. At 630, the method 600 can present the virtual object in the virtual environment. For example, at least one of the computing device 300 or the computing device 400 can cause a user interface to present the virtual object in the virtual environment. For example, at least one of the computing device 300 or the computing device 400 can cause a user interface to present the virtual object in the virtual environment.

FIG. 7 depicts an example method of transforming digital images of archival materials into dimensionally accurate virtual objects according to this disclosure. At least one of the computing device 300 or the computing device 400 can perform method 700. At 710, the method 700 can determine a physical dimension of the physical object. For example, 710 can correspond at least partially in one or more of structure and operation to 530. For example, the method can include identifying, based on at least a portion of the digital image corresponding to the physical object, a texture to be applied to the virtual object. For example, the method can include determining the physical object according to at least one feature of the physical object depicted in the digital image. For example, the method can include determining, using a machine learning model configured to detect image features, the at least one feature of the physical object depicted in the digital image.

For example, the method can include determining the physical object according to an attribute of a location associated with the digital image. For example, the location associated with the digital image is a physical location corresponding to at least one of a physical location, or an identifier of an institution. For example, the location associated with the digital image is a logical address of a computing system associated with a physical location, or a logical address of the computing system associated with an institution. For example, the method can include determining, according to the location, a digitization resolution for the digital image, where the attribute can include the digitization resolution. For example, the method can include determining, according to the location, a scaling factor for the digital image, where the attribute can include the scaling factor.

At 720, the method 700 can generate a 3d virtual object corresponding to the physical object. For example, 720 can correspond at least partially in one or more of structure and operation to 620. For example, the non-transitory computer readable medium can include one or more instructions executable by a processor. The processor can determine the physical object according to an attribute of a location associated with the digital image. The processor can determine, according to the location, a digitization resolution for the digital image, where the attribute can include the digitization resolution. The processor can determine, according to the location, a scaling factor for the digital image, where the attribute can include the scaling factor.

In some implementations, one or more processors, such as one or more processors of the local device 104, can determine the physical dimensions using one or more machine learning models. The machine learning model can include at least one of a text model (e.g., language model) or an image model. For example, the machine learning model can include at least one of a natural language processing (NLP) or computer vision (CV) model.

In some implementations, the machine learning model can receive the image 108 (e.g., digital image) including the physical object as an input, and output the physical dimension of the physical object. The image 108 can include a digitization target which can include a ruler or any other object with a known physical dimension. The one or more processors can store a number of known dimensions for different types of digitization targets associated with different features, such as but not limited to text, shape, or any other feature, in a reference table. The type can include at least one of a brand or other attribute of the digitization target. Upon receiving the image 108, the machine learning model can determine the type of the digitization target in the image 108. The machine learning model can identify one or more features of the digitization target to determine the type. For example, the machine learning model can compare the features to the stored number of features, and determine the corresponding type from the features using the reference table. Based on at least the type, the machine learning model can determine the known dimension associated with the digitization target. In some implementations, the physical object can include the digitization target such that the image 108 includes one or more physical objects.

To determine the physical dimensions of the physical object, the machine learning model can perform edge detection on the image 108 to detect edges of the physical object in the image 108, and generate a bounding box around the physical object. The machine learning model can generate another bounding box around the digitization target. Based on at least the bounding boxes, the machine learning model can determine pixel dimensions of both the physical object and the digitization target. The pixel dimensions can be determined based at least partially on a number of pixels (e.g., attribute) of the image 108 and a number of pixels located within the bounding box. The machine learning model can use the known physical dimension of the digitization target determined based at least on the type of the digitization target, and correspond the known physical dimension to the pixel dimensions of the digitization target to determine a ratio (e.g., ratio 112, conversion ratio, scaling factor, correspondence between the known physical dimension and the pixel dimension, etc.). The machine learning model can apply the ratio to the pixel dimensions of the physical object to determine the physical dimension of the physical object. The machine learning model can thus output the physical dimension of the physical object in the image 108.

In some implementations, the machine learning model receives the metadata 106 as an input, and outputs the physical dimension of the physical object. The machine learning model can identify dimensions of the physical object within the metadata 106, and convert the dimensions from character strings to numerals. The machine learning model can output the numerals which can represent the physical dimensions of the physical object. In some implementations, the metadata 106 may include dimensions with different units, such as centimeters (cm) or inches (in). The machine learning model can determine the unit of the dimensions from the metadata 106, and output the physical dimensions with an association to the unit of measurement. In some implementations, the metadata 106 may include one or more states of the physical object with associated dimensions, such as an unfolded or folded state. In such implementations, the machine learning model can determine the dimensions for each state of the physical object from the metadata 106. In some implementations, the machine learning model can output the dimensions greater than other dimensions present in the metadata 106 as the physical dimensions of the physical object. For example, the machine learning model can output the dimensions associated with the unfolded state as the physical dimensions instead of the dimensions associated with the folded state.

In some implementations, to determine the physical dimension from the metadata 106, the machine learning model can identify a field corresponding to the physical dimension in the metadata 106. For example, the metadata 106 can include a number of fields, and at least one of the fields can include the physical dimension, such as a physical description field. The machine learning model can be configured to identify the field including the physical dimension, and process the strings of the field to output the physical dimension. In some implementations, the metadata 106 includes the dimensions of the physical object, and may not include dimensions of the image 108. In some implementations, the machine learning model can process strings of the metadata 106 to determine the dimensions of the physical object without identifying a field including the dimensions.

In some implementations, the machine learning model including an image processing model can output a confidence score associated with the output physical dimension. The machine learning model can determine the confidence score based on at least a probability. For example, the machine learning model can determine the confidence score based on the probability that the pixels within the generated bounding boxes include at least one of the physical object or the digitization target. In some implementations, the machine learning model including a language model can output a confidence score associated with the output physical dimension. In some implementations, the machine learning model can process both the image 108 and the metadata 106 to determine the physical dimension.

In some implementations, the machine learning model includes a plurality of machine learning models and includes both language and image processing models. The plurality of machine learning models can receive at least one of the metadata 106 or the image 108, and output the physical dimension. In some implementations, the plurality of machine learning models receives the input and outputs the physical dimension in parallel or sequentially. The at least one processor of the local device 104 can compare the outputs of the plurality of machine learning models and cross-validate the determined physical dimension. For example, the at least one processor can determine a difference between the outputs and in response to the difference being below a threshold, the at least one processor can store and associate the physical dimension with the physical object. In response to the difference being equal to or greater than the threshold, the at least one processor may provide the metadata 106 or the image 108 to the plurality of machine learning models to output the physical dimension again. In some implementations, the at least one processor may clean, adjust, or otherwise edit the metadata 106 or the image 108 prior to inputting the metadata 106 and the image 108 into the plurality of machine learning models again.

In some implementations, the local device 104 can be configured to input at least one of the metadata 106 or the image 108 into a first machine learning model and in response to, for example, the first machine learning model being unable to determine the physical dimension or the confidence score being below a threshold, the local device 104 provides the input to a second machine learning model. The local device 104 can include a number of machine learning models, and can be configured to provide the input to the number of machine learning models sequentially until at least one machine learning model at least one of outputs the physical dimension or outputs the confidence score being at or above the threshold. In some implementations, the machine learning model can receive a plurality of metadata 106 or images 108 at one time, and can sequentially output the physical dimensions. In some implementations, the machine learning model can receive a database (e.g., array, etc.) including the plurality of metadata 106 and images 108, and can iteratively output the physical dimensions of the plurality of metadata 106 and images 108. The local device 104 can use the physical dimensions to generate the item 116, and transmit the item 116 to the AR/VR environment 118 for display.

The machine learning model can be updated on a training dataset including training images and metadata, and corresponding ground truth physical dimensions of the physical objects depicted in the training images. The one or more processors can determine a loss based on a difference between the physical dimensions output by the machine learning model and the ground truth physical dimensions and update the weights of the machine learning model based on the loss until convergence.

Having now described some illustrative implementations, the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both “A′ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Scope of the systems and methods described herein is thus indicated by the appended claims, rather than the foregoing description. The scope of the claims includes equivalents to the meaning and scope of the appended claims.

What is claimed is:

1. A system, comprising:
a memory and one or more processors to:
determine, according to an attribute of a digital image and a type of a physical object depicted in the digital image, a physical dimension of the physical object; and
generate a three-dimensional virtual object corresponding to the physical object, the virtual object having a virtual dimension in a virtual environment corresponding to the physical dimension.

2. The system of claim 1, the processors to:
cause a user interface to present the virtual object in the virtual environment.

3. The system of claim 1, the processors to:
identify, based on at least a portion of the digital image corresponding to the physical object, a texture to be applied to the virtual object.

4. The system of claim 1, the processors to:
determine the physical object according to at least one feature of the physical object depicted in the digital image.

5. The system of claim 4, the processors to:
determine, using a machine learning model configured to detect image features, the at least one feature of the physical object depicted in the digital image.

6. The system of claim 1, the processors to:
determine the physical object according to an attribute of a location associated with the digital image.

7. The system of claim 6, wherein the location associated with the digital image is a physical location corresponding to at least one of a physical location, or an identifier of an institution.

8. The system of claim 6, wherein the location associated with the digital image is a logical address of a computing system associated with a physical location, or a logical address of the computing system associated with an institution.

9. The system of claim 6, the processors to:
determine, according to the location, a digitization resolution for the digital image, wherein the attribute includes the digitization resolution.

10. The system of claim 6, the processors to:
determine, according to the location, a scaling factor for the digital image, wherein the attribute includes the scaling factor.

11. A method, comprising:
determining, according to an attribute of a digital image and a type of a physical object depicted in the digital image, a physical dimension of the physical object; and
generating a three-dimensional virtual object corresponding to the physical object, the virtual object having a virtual dimension in a virtual environment corresponding to the physical dimension.

12. The method of claim 11, further comprising:
causing a user interface to present the virtual object in the virtual environment.

13. The method of claim 11, further comprising:
identifying, based on at least a portion of the digital image corresponding to the physical object, a texture to be applied to the virtual object.

14. The method of claim 11, further comprising:
determining the physical object according to at least one feature of the physical object depicted in the digital image.

15. The method of claim 14, further comprising:
determining, using a machine learning model configured to detect image features, the at least one feature of the physical object depicted in the digital image.

16. The method of claim 11, further comprising:
determining the physical object according to an attribute of a location associated with the digital image.

17. The method of claim 16, wherein the location associated with the digital image is a physical location corresponding to at least one of a physical location, or an identifier of an institution.

18. The method of claim 16, wherein the location associated with the digital image is a logical address of a computing system associated with a physical location, or a logical address of the computing system associated with an institution.

19. The method of claim 16, further comprising:
determining, according to the location, a digitization resolution for the digital image, wherein the attribute includes the digitization resolution.

20. The method of claim 16, further comprising:
determine, according to the location, a scaling factor for the digital image, wherein the attribute includes the scaling factor.
